(19) United States
(12) Patent Application Publication
(10) Pub. No.: US 2008/0069134 A1
(43) Pub. Date: Mar. 20, 2008

(54) Method and apparatus for rapid reconfiguration of a highly configurable wireless terminal radio transceiver

(75) Inventors: John Alexander Interrante, Richardson, TX (US); William Milton Hurley, Murphy, TX (US)

Correspondence Address: DOCKET CLERK, P.O. DRAWER 800889, DALLAS, TX, 75380, US

(73) Assignee: SAMSUNG ELECTRONICS CO., LTD., SUWON-CITY (KR)

(21) Appl. No.: 11/524,851

(22) Filed: Sep. 20, 2006

(51) Int. Cl. H04J 3/22

(52) U.S. Cl. 370/465

(57) ABSTRACT

A reconfiguration unit capable of switching between multiple programmable modes of operation, said electronic device including a first set of programmable registers storing configuration data corresponding to a first mode of operation; a second set of programmable registers storing configuration data corresponding to a second mode of operation; a plurality of multiplexers each connecting corresponding ones of the first and second set of programmable registers with a respective one of a plurality of configurable processing block; and a mode register connected to the plurality of multiplexers to selectively connect the first set of programmable registers or the second set of programmable registers to the plurality of configurable processing blocks. Also described is a related wireless mobile station and configuration method.

### TECHNICAL FIELD OF THE INVENTION

The present application relates generally to reconfigurable electronic devices and, more specifically, to reconfigurable wireless devices.

### BACKGROUND OF THE INVENTION

The advancement of technologies enabling reconfigurable electronic devices, including wireless devices and radio transceivers, has prompted a proliferation of multi-functional devices. There is currently a demand for lower cost, multi-mode wireless terminals with multi-function radio transceivers.

Conventional methods for reconfiguring multi-functional devices have certain benefits and drawbacks. One such method allows selection among one of n pre-determined operating modes, but has a relatively limited configuration space and provides a relatively small number of options. This method, however, can rapidly change the personality of the device with only a small number of commands over its programming interface.

Another method allows greater flexibility and provides a greater number of operating mode possibilities. This method, however, requires a relatively large configuration space. For instance, where a personality of EDGE mode or WCDMA mode is selected through a programmable MODE Register, EDGE mode or WCDMA mode is selected by describing the exact nature of the signal processing chain elements. The method may configure processing chain elements such as specific bandwidths, cutoff frequencies, sampling rates, filter coefficients and characteristics, group delays, bypass registers and other parameters.

Therefore, there is a need in the art for a system and method for robust and fast re-configuration of electronic devices.

### SUMMARY OF THE INVENTION

In one embodiment, a reconfiguration unit for use in an electronic device is provided. The reconfiguration unit is capable of switching between multiple programmable modes of operation and includes a first set of programmable registers storing configuration data corresponding to a first mode of operation and a second set of programmable registers storing configuration data corresponding to a second mode of operation. The reconfiguration unit also includes a plurality of multiplexers each connecting corresponding ones of the first and second set of programmable registers with a respective one of a plurality of configurable processing block. The reconfiguration unit also includes a mode register connected to the plurality of multiplexers to selectively connect the first set of programmable registers or the second set of programmable registers to the plurality of configurable processing blocks.

In another embodiment, a mobile station for use in a wireless network is capable of switching between multiple programmable modes of operation is provided. The mobile station includes a first set of programmable registers storing configuration data corresponding to a first mode of operation, and a second set of programmable registers storing configuration data corresponding to a second mode of operation. The mobile station also includes a plurality of multiplexers each connecting corresponding ones of the first and second set of programmable registers with a respective one of a plurality of configurable processing block, and a mode register connected to the plurality of multiplexers to selectively connect the first set of programmable registers or the second set of programmable registers to the plurality of configurable processing blocks. The mobile station also includes a controller connected to program the mode register and at least one of the programmable registers.

In still another embodiment, a method for configuring an electronic device for use in a wireless network is provided. The method includes programming a first set of programmable registers with configuration data corresponding to a first mode of operation, and programming a second set of programmable registers with configuration data corresponding to a second mode of operation. The method also includes repeatedly performing the steps of selecting a mode of operation, programming a mode register according to the selected mode of operation, connecting one of the first and second sets of programmable registers to a configurable processing block according to the mode register, and operating the selected mode of operation.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an exemplary wireless network according to one embodiment of the disclosure;

FIG. 2 illustrates a wireless mobile station according to one embodiment of the disclosure;

FIG. 3 depicts a block diagram illustrating a known reconfiguration technique;

FIG. 4 depicts a block diagram illustrating a known reconfiguration technique;

FIG. 5 is block diagram of a reconfiguration unit for an electronic device according to one embodiment of the disclosure; and

FIG. 6 depicts a flowchart of a process according to one embodiment of the disclosure.

### DETAILED DESCRIPTION OF THE INVENTION

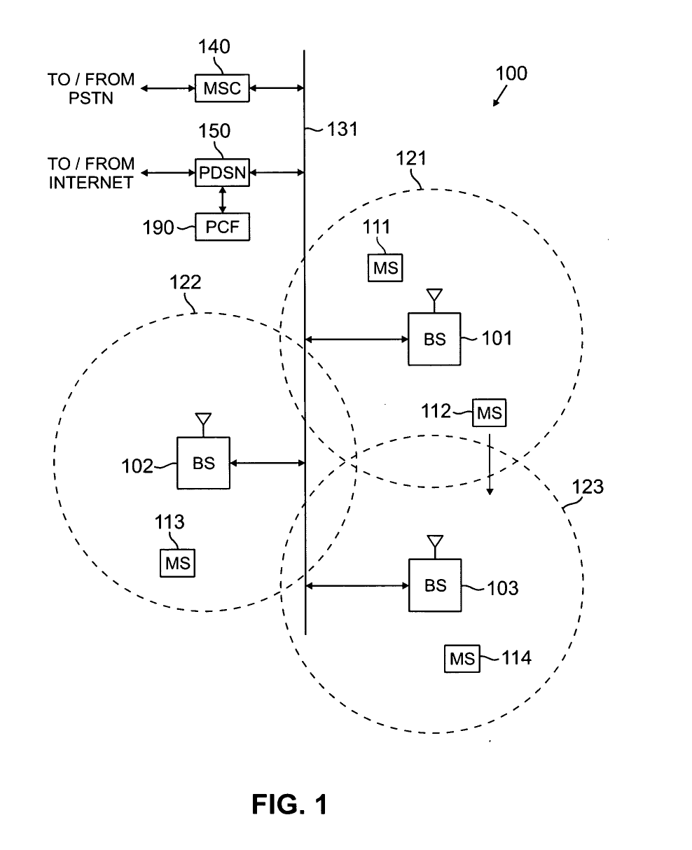

FIGS. 1 through 6, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged electronic device.

FIG. 1 illustrates exemplary wireless network 100, in which an electronic device according to the principles of the present disclosure can be used as part of a mobile station.

Wireless network 100 comprises a plurality of cells (or cell sites) 121-123, each containing one of the base stations, BS 101, BS 102, or BS 103. Base stations 101-103 communicate with a plurality of mobile stations (MS) 111-114 over code division multiple access (CDMA) channels according to, for example, the IS-2000 standard (i.e., CDMA2000). In an advantageous embodiment of the present disclosure, mobile stations 111-114 are capable of receiving data traffic and/or voice traffic on two or more CDMA channels simultaneously. Mobile stations 111-114 may be any suitable wireless devices (e.g., conventional cell phones, PCS handsets, personal digital assistant (PDA) handsets, portable computers, telemetry devices) that are capable of communicating with base stations 101-103 via wireless links.

Of course, while the example described herein is a CDMA network, the disclosed embodiments are not limited to CDMA wireless networks, but can be used in any type of wireless network, or in other devices not in communication with wireless networks.

The present disclosure is not limited to mobile devices. The present disclosure also encompasses other types of wireless access terminals, including fixed wireless terminals. For the sake of simplicity, only mobile stations are shown and discussed hereafter. However, it should be understood that the use of the term “mobile station” in the claims and in the description below is intended to encompass both truly mobile devices (e.g., cell phones, wireless laptops) and stationary wireless terminals (e.g., a machine monitor with wireless capability).

Dotted lines show the approximate boundaries of cells (or cell sites) 121-123 in which base stations 101-103 are located. It is noted that the terms “cells” and “cell sites” may be used interchangeably in common practice. For simplicity, the term “cell” will be used hereafter. The cells are shown approximately circular for the purposes of illustration and explanation only. It should be clearly understood that the cells may have other irregular shapes, depending on the cell configuration selected and variations in the radio environment associated with natural and man-made obstructions.

As is well known in the art, each of cells 121-123 is comprised of a plurality of sectors, where a directional antenna coupled to the base station illuminates each sector. The embodiment of FIG. 1 illustrates the base station in the center of the cell. Alternate embodiments may position the directional antennas in corners of the sectors. The system of the present disclosure is not limited to any particular cell configuration.

In one embodiment of the present disclosure, each of BS 101, BS 102 and BS 103 comprises a base station controller (BSC) and one or more base transceiver subsystem(s) (BTS). Base station controllers and base transceiver subsystems are well known to those skilled in the art. A base station controller is a device that manages wireless communications resources, including the base transceiver subsystems, for specified cells within a wireless communications network. A base transceiver subsystem comprises the RF transceivers, antennas, and other electrical equipment located in each cell. This equipment may include air conditioning units, heating units, electrical supplies, telephone line interfaces and RF transmitters and RF receivers. For the purpose of simplicity and clarity in explaining the operation of the present disclosure, the base transceiver subsystems in each of cells 121, 122 and 123 and the base station controller associated with each base transceiver subsystem are collectively represented by BS 101, BS 102 and BS 103, respectively.

BS 101, BS 102 and BS 103 transfer voice and data signals between each other and the public switched telephone network (PSTN) (not shown) via communication line 131 and mobile switching center (MSC) 140. BS 101, BS 102 and BS 103 also transfer data signals, such as packet data, with the Internet (not shown) via communication line 131 and packet data server node (PDSN) 150. Packet control function (PCF) unit 190 controls the flow of data packets between base stations 101-103 and PDSN 150. PCF unit 190 may be implemented as part of PDSN 150, as part of MSC 140, or as a stand-alone device that communicates with PDSN 150, as shown in FIG. 1. Line 131 also provides the connection path for control signals transmitted between MSC 140 and BS 101, BS 102 and BS 103 that establish connections for voice and data circuits between MSC 140 and BS 101, BS 102 and BS 103.

Communication line 131 may be any suitable connection means, including a T1 line, a T3 line, a fiber optic link, a network packet data backbone connection, or any other type of data connection. Alternatively, communication line 131 may be replaced by a wireless backhaul system, such as microwave transceivers. Communication line 131 links each vocoder in the BSC with switch elements in MSC 140. The connections on communication line 131 may transmit analog voice signals or digital voice signals in pulse code modulated (PCM) format, Internet Protocol (IP) format, asynchronous transfer mode (ATM) format, or the like.

MSC 140 is a switching device that provides services and coordination between the mobile stations in a wireless network and external networks, such as the PSTN or Internet. MSC 140 is well known to those skilled in the art. In some embodiments, communication line 131 may be several different data links where each data link couples one of BS 101, BS 102, or BS 103 to MSC 140.

In exemplary wireless network 100, MS 111 is located in cell 121 and is in communication with BS 101. MS 112 is also located in cell 121 and is in communication with BS 101. MS 113 is located in cell 122 and is in communication with BS 102. MS 114 is located in cell 123 and is in communication with BS 103. MS 112 is also located close to the edge of cell 123 and is moving in the direction of cell site 123, as indicated by the direction arrow proximate MS 112. At some point, as MS 112 moves into cell site 123 and out of cell site 121, a hand-off will occur.

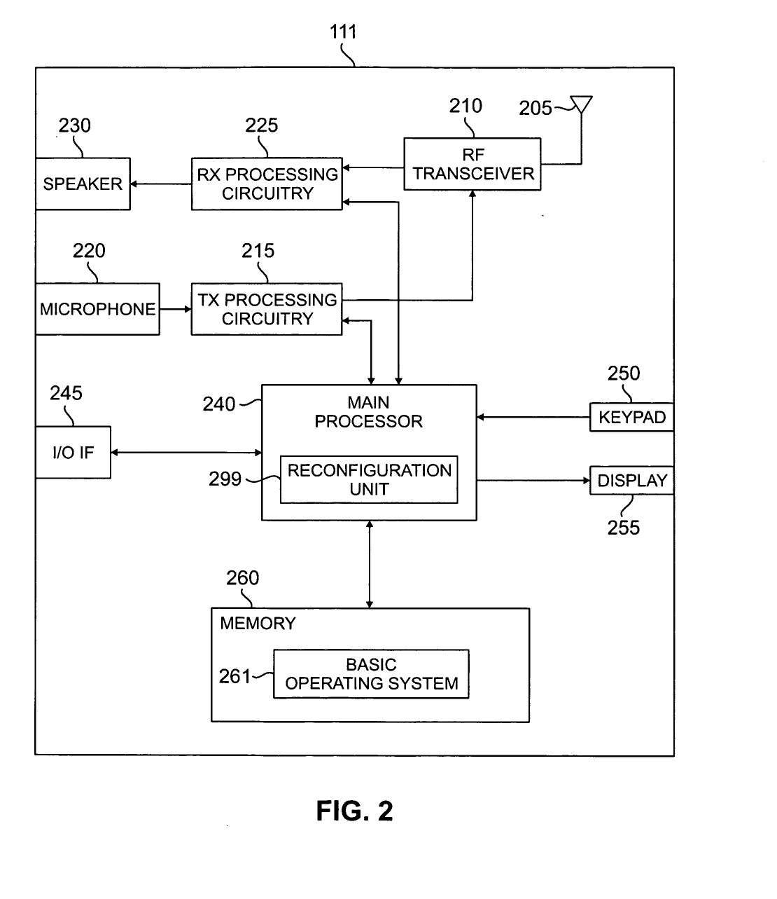

FIG. 2 illustrates MS 111 according to one embodiment of the present disclosure. MS 111 includes antenna 205, radio frequency (RF) transceiver 210, transmit (TX) processing circuitry 215, microphone 220 and receive (RX) processing circuitry 225. MS 111 also comprises speaker 230, main processor 240, input/output (I/O) interface (IF) 245, keypad 250, display 255 and memory 260. Memory 260 further comprises basic operating system (OS) program 261.

RF transceiver 210 receives from antenna 205 an incoming RF signal transmitted by a base station of wireless network 100. RF transceiver 210 down-converts the incoming RF signal to produce an intermediate frequency or a baseband signal. The intermediate frequency or baseband signal is sent to RX processing circuitry 225, which produces a processed baseband signal by filtering, digitizing the intermediate frequency or a baseband signal, performing additional filtering and, if necessary, demodulating and/or decoding. RX processing circuitry 225 transmits the processed baseband signal to speaker 230 (e.g., when the signal includes voice data). Alternatively, the processed baseband signal may be transmitted to main processor 240 for further processing (e.g., web browsing).

TX processing circuitry 215 receives analog or digital voice data from microphone 220 or other outgoing baseband data (e.g., web data, e-mail, interactive video game data) from main processor 240. TX processing circuitry 215 encodes, modulates, multiplexes, and/or digitizes the outgoing baseband data to produce a processed baseband or IF signal. RF transceiver 210 receives the outgoing processed baseband signal from TX processing circuitry 215. RF transceiver 210 up-converts the signal to a radio frequency (RF) signal transmitted via antenna 205.

In one embodiment of the present disclosure, main processor 240 is a microprocessor or microcontroller. Memory 260 is coupled to main processor 240. Part of memory 260 may include a random access memory (RAM) 265 and a non-volatile memory 270, such as flash memory, which acts as a read-only memory (ROM).

Main processor 240 executes basic OS program 261 stored in memory 260 in order to control the overall operation of MS 111. In one such operation, main processor 240 controls the reception of forward channel signals and the transmission of reverse channel signals by RF transceiver 210, RX processing circuitry 225 and TX processing circuitry 215 in accordance with well-known principles.

Main processor 240 is capable of executing other processes and programs resident in memory 260. Main processor 240 can move data into or out of memory 260, as required by an executing process. Main processor 240 is also coupled to I/O interface 245. I/O interface 245 provides MS 111 with the ability to connect to other devices such as laptop computers and handheld computers. In other words, I/O interface 245 serves as a communication path between these accessories and main controller 240.

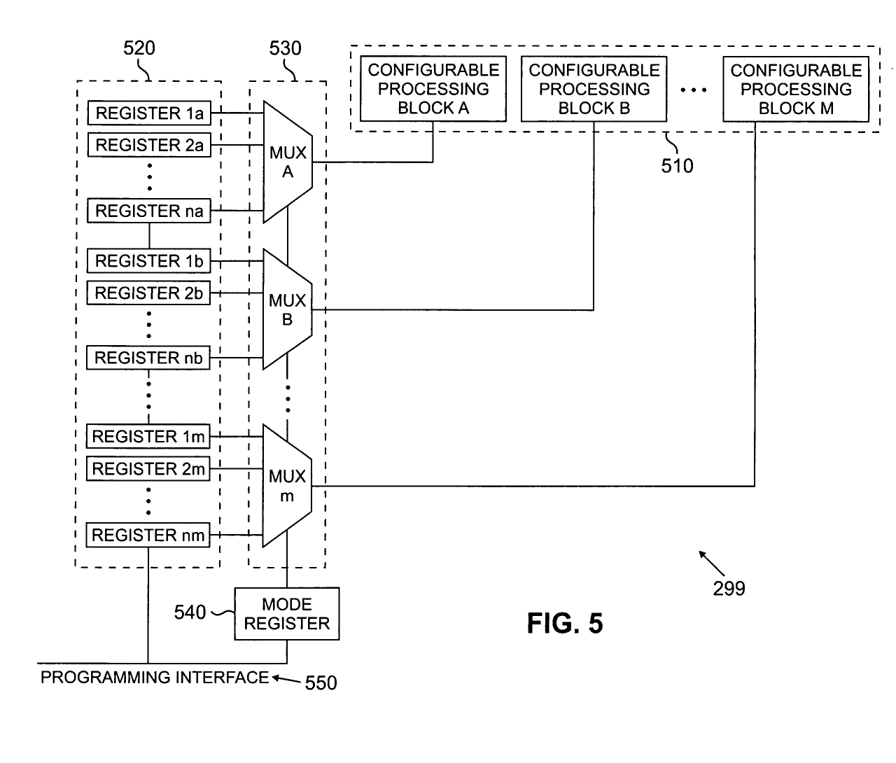

Main processor 240 is also coupled to keypad 250 and display 255. The operator of MS 111 uses keypad 250 to enter data into MS 111. Display 255 may be a liquid crystal display capable of rendering text and/or at least limited graphics from web sites. Alternate embodiments may use other types of displays. Main processor 240 also includes reconfiguration unit 299 as described later in detail in conjunction with FIG. 5.

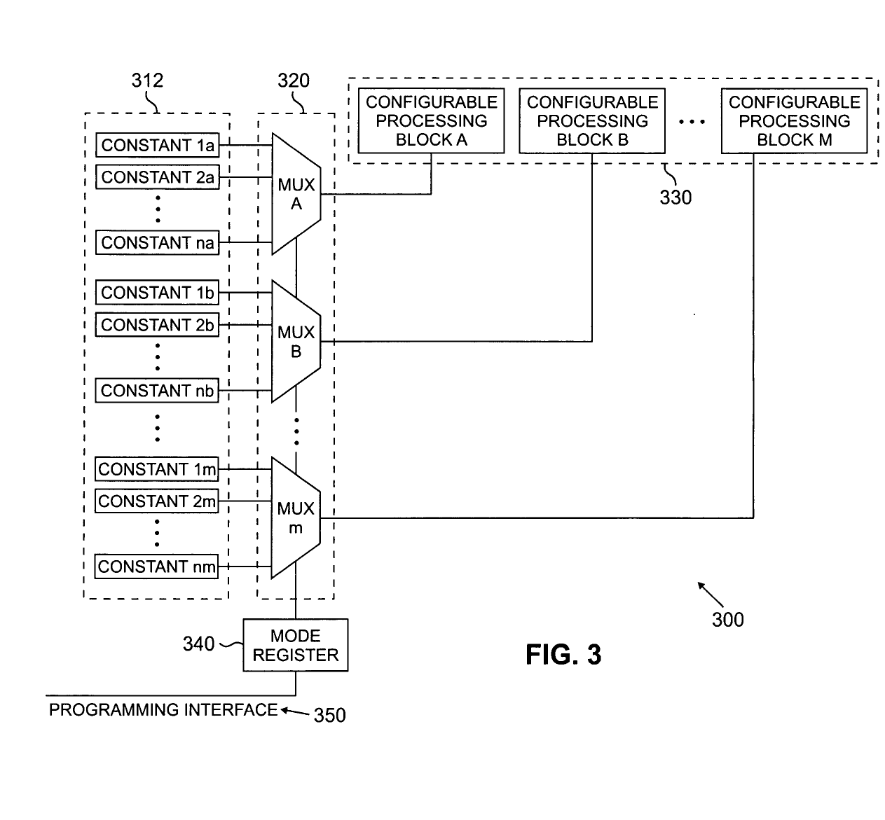

FIG. 3 is a block diagram illustrating conventional system 300. System 300 reconfigures a multi-function device and selects among n pre-determined operating modes. System 300 includes m configurable processing blocks 330. Configurable processing blocks 330 may take on n different configurations, or “personalities.” Constants 312 are each connected via a respective one of multiplexers 320 to the corresponding one of configurable processing blocks 330.

Mode register 340 controls each of multiplexers 320 to select which constants 312 are connected to one of configurable processing blocks 330. Mode register 340 is loaded and controlled via programming interface 350. System 300 is a multi-mode device and may be switched, for example, between Enhanced Data GSM Environment (EDGE) mode and Wideband Code Division Multiple Access (WCDMA) mode with as little as one command from the host controller via programming interface 350. The one or more commands mode register 340. Mode register 340 selects appropriate constants 312 using multiplexers 320.

In implementations of system 300, the bandwidth of programming interface 350 is relatively low. Thus, rapid personality changes may be accomplished if the number of commands required is small. While a small configuration space is a benefit for rapid reconfiguration, it is also a drawback in terms of flexibility in defining the personality of the signal processing chains. A small configuration space necessarily limits the number of options to some relatively small number N.

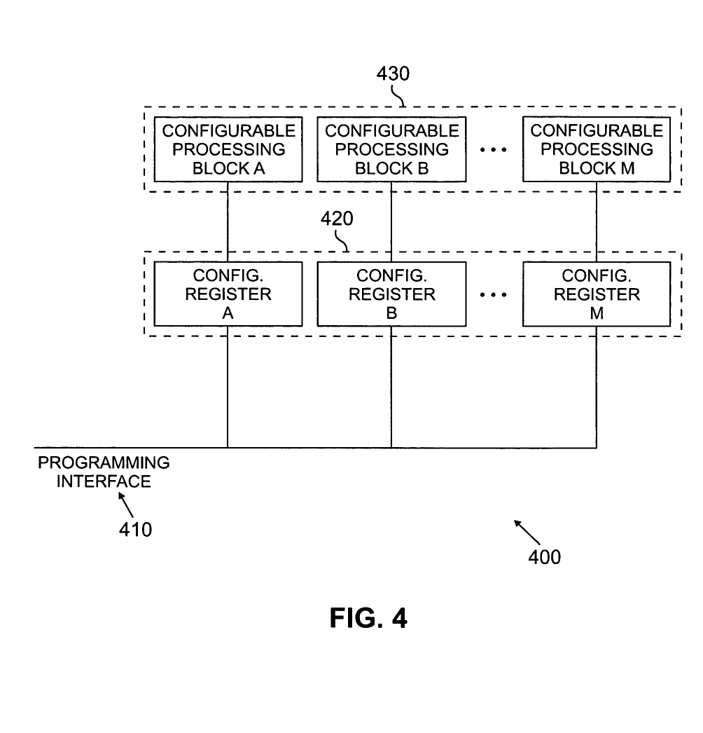

FIG. 4 is a block diagram of conventional system 400 for reconfiguring a multi-function device. System 400 includes programming interface 410. Programming interface 410 is connected to load and control configuration registers 420. Configuration registers 420 are each connected to a respective one of configurable processing blocks 430. System 400 provides a single hardware design to take on many personalities. In addition, system 400 adapts to changes in existing wireless standards and even allows the support of future standards that have not yet been adopted. System 400 may even adapt to standard not yet envisioned. System 400, however, takes considerable amount of time to change personalities via the aforementioned low bandwidth programming interface 410. For example, it is likely to take thousands of programming commands to accomplish the switch from EDGE operating mode to WCDMA operating mode. This eliminates the possibility of rapid reconfiguration from one of these modes to the other.

FIG. 5 is block diagram of an exemplary embodiment of reconfiguration unit 299 for an electronic device according one embodiment of the present disclosure. Reconfiguration unit 299 may be implemented, for example, in the wireless terminal of FIG. 2 or in any other electronic device, including base stations such as BS 101, mobile or handheld computers, and other devices.

Reconfiguration unit 299 includes M configurable processing blocks 510. Each of configurable processing blocks 510 has the ability to take on n different configurations, or “personalities.” Each of N*M programmable registers 520 are of varying length sufficient in size to configure the respective configurable processing blocks 510. Programmable registers 520 contain the configuration data for the different personalities and may contain hundreds or thousands of bits of information, depending on the nature of the respective configurable processing blocks 510. Programmable registers 520 are each connected via a respective multiplexer 530 to the corresponding on of configurable processing blocks 510. Mode register 540 controls each of the multiplexers 530 to select which of the programmable registers 520 are connected to teach each of configurable processing blocks 510. Mode register 540 and each of the programmable registers 520 are loaded and controlled via programming interface 550.

Reconfiguration unit 299 contains a relatively large amount of programmable data to support the high degree of flexibility in programming the behavior of the signal processing chain. This configuration data is stored in programmable registers 520. The data in programmable registers 520 is mapped and made available for the configurable processing blocks 510 via the N-to-1 multiplexers 530. Multiplexers 530 all are controlled via a single mode register 540. Programming interface 550 is extended to control all of programmable registers 520 as well as mode register 540.

A “set” of programmable registers 520, as used herein, refers to a subset of the total number of programmable registers 520 needed for setting configurable processing blocks 510. For example, a first set of programmable registers 520 may include programmable registers 1a, 1b, . . . , 1m, the contents of which may be simultaneously connected to and loaded in configurable processing blocks 510. A second set of programmable registers 520 may include programmable registers 2a, 2b, . . . 2m, and the nth set of programmable registers 520 may include programmable registers na, nb, . . . nm. Other configuration data, when not currently loaded in programmable registers 520, can be stored, for example, in memory 260.

In one embodiment, the present disclosure provides a method for programming all of programmable registers 520 and mode register 540 in reconfiguration unit 299 upon power-up. Alternatively, programming may occur when configuration is not time critical, such as when the device is in an idle state, or specific registers can be programmed when they are idle but other registers are in use. During subsequent normal operation, different personalities are selected through a minimal number of writes to mode register 540. For example, during WDCMA Compressed Mode operation, this single configurable signal processing chain can rapidly switch modes between WCDMA and EDGE as required by the standards, by simply switching between programmable registers 520. Mode switching may occur multiple times each second during normal operation. Unlike reconfigurable unit 299, system 400 shown in FIG. 4, required a large number of write commands. For example, the large number of write commands prohibits its use in switching between WCDMA and EDGE mode according to the switching time limitations imposed by WCDMA Compressed Mode standards.

It should be noted that the disclosed embodiments do not limit the number of unique personalities in the reconfigurable radio transceiver to N, but rather gives the opportunity to rapidly switch between N unique personalities. For example, in an exemplary system utilizing reconfiguration unit 299 with N=2, the MS 111 can be rapidly switched between two pre-loaded personalities. If it is beneficial for such an exemplary system, the personality currently not in use can be reprogrammed with a third set of configuration data. MS 111 will then be ready for rapid switchover to the third personality at the opportune time as required. Reconfiguration unit 299 may be used to set configurable processing blocks 510 that are either analog or digital in nature as long as their programming method is digital.

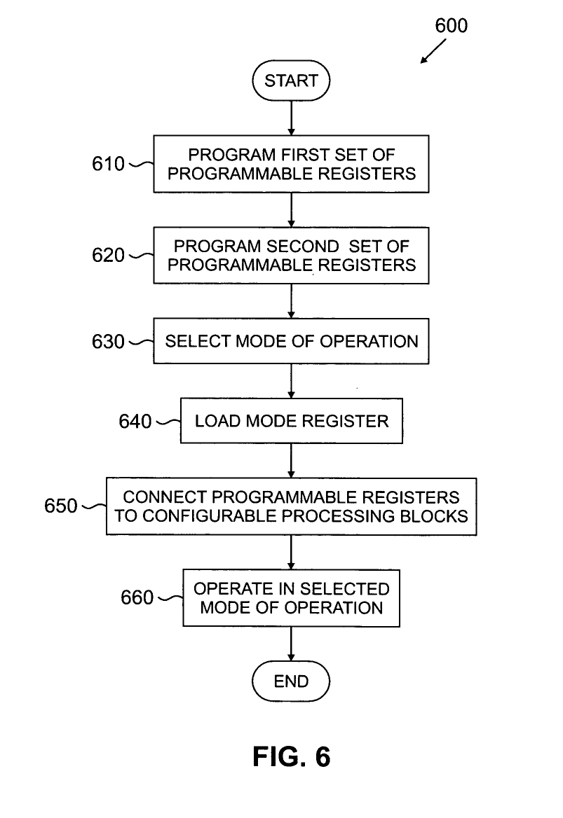

FIG. 6 depicts a flowchart of a process 600 in accordance with a disclosed embodiment. At step 610, program a first set of programmable registers 520 in an electronic device with configuration data corresponding to a first mode of operation. For example, the first set of programmable registers 520 can be programmed with WCDMA configuration data, for configuring a set of configurable processing blocks 510 to operate in WCDMA mode. In various disclosed embodiments, each of programmable registers 520 (in a set of programmable registers) corresponds to one of configurable processing blocks 510.

At step 620, program a second set of programmable registers 520 with configuration data corresponding to a second mode of operation. For example, the first set of programmable registers 520 can be programmed with EDGE configuration data, for configuring a set of configurable processing blocks 510 to operate in EDGE mode.

At step 630, the electronic device selects a mode of operation. This selection can be received from a user, or from another electronic device such as a base station, or the electronic device can determine its own selection of operating modes based its current environment and requirements.

At step 640, the electronic device loads mode register 540 with mode data corresponding to the selected operating mode. At step 650, the electronic device connects one of the first or second set of programmable registers 520 to the set of configurable processing blocks 510. By performing all switching according to mode register 540, the configuration data for the selected mode of operation can be rapidly connected to the configurable processing blocks, by connecting the selected set of programmable registers 520 via multiplexers 530 to configurable processing blocks 510.

At step 660, the electronic device operates in the selected mode of operation according to the configuration data for that mode of operation. During typical operation in various disclosed embodiment, process 600 will then return to step 630 for a new selection of operating modes. In mobile terminal operations, for example, mode selection and the change of mode of operation can occur multiple times each second, as the mobile terminal monitors and selects from other communication modes. If the selected mode of operation is an “OFF” state, in some embodiments, the process ends.

In the various examples above, only switching between two modes of operation is specifically described. Those of skill in the art will recognize that various implementations can include an arbitrary M number of configurable processing blocks 510, with associated programmable registers 520 and multiplexers 530. There can be an arbitrary N number of programmable registers 520 associated with each of multiplexers 530, for N modes of operation, or more or less than N according to programming.

Accordingly, an electronic device employing the techniques disclosed herein enjoys a great deal of flexibility in describing the behavior of each of the blocks in the signal processing chains while at the same time containing a mode Register that allows almost immediate selection among one of n complex operating modes.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. For use in an electronic device, a reconfiguration unit capable of switching between multiple programmable modes of operation, said electronic device comprising:
a first set of programmable registers storing configuration data corresponding to a first mode of operation;
a second set of programmable registers storing configuration data corresponding to a second mode of operation;
a plurality of multiplexers each connecting corresponding ones of the first and second set of programmable registers with a respective one of a plurality of configurable processing block; and
a mode register connected to the plurality of multiplexers to selectively connect the first set of programmable registers or the second set of programmable registers to the plurality of configurable processing blocks.

2. The reconfiguration unit as set forth in claim 1, further comprising a programming interface configured to program the mode register and at least one of the programmable registers.

3. The reconfiguration unit as set forth in claim 1, further comprising a plurality of additional sets of programmable registers each storing configuration data corresponding to an additional mode of operation, wherein the mode register is also connected to selectively connect the individuals ones of the additional sets of programmable registers to the plurality of configurable processing blocks.

4. The reconfiguration unit as set forth in claim 1, wherein the plurality of multiplexers is controlled by the contents of the mode register.

5. The reconfiguration unit as set forth in claim 1, wherein the electronic device automatically selects a mode of operation and loads the mode register according to the selection.

6. The reconfiguration unit as set forth in claim 1, wherein the electronic device includes a controller connected to program the mode register and at least one of the programmable registers.

7. The reconfiguration unit as set forth in claim 1, wherein the programmable registers can be programmed when the electronic device is in an idle state.

8. The reconfiguration unit as set forth in claim 1, wherein the programmable registers can be programmed upon power-up of the electronic device.

9. For use in a wireless network, a mobile station capable of switching between multiple programmable modes of operation, said electronic device comprising:
a first set of programmable registers storing configuration data corresponding to a first mode of operation;
a second set of programmable registers storing configuration data corresponding to a second mode of operation;
a plurality of multiplexers each connecting corresponding ones of the first and second set of programmable registers with a respective one of a plurality of configurable processing block;
a mode register connected to the plurality of multiplexers to selectively connect the first set of programmable registers or the second set of programmable registers to the plurality of configurable processing blocks; and
a controller connected to program the mode register and at least one of the programmable registers.

10. The mobile station as set forth in claim 9, further comprising a programming interface configured to program the mode register and at least one of the programmable registers.

11. The mobile station as set forth in claim 9, further comprising a plurality of additional sets of programmable registers each storing configuration data corresponding to an additional mode of operation, wherein the mode register is also connected to selectively connect the individuals ones of the additional sets of programmable registers to the plurality of configurable processing blocks.

12. The mobile station as set forth in claim 9, wherein the plurality of multiplexers is controlled by the contents of the mode register.

13. The mobile station as set forth in claim 9, wherein the controller selects a mode of operation and programs the mode register according to the selection.

14. The mobile station as set forth in claim 9, wherein the programmable registers can be programmed when the mobile station is in an idle state.

15. The mobile station as set forth in claim 9, wherein the programmable registers can be programmed upon power-up.

16. For use in a wireless network, a method for configuring an electronic device, comprising:
programming a first set of programmable registers with configuration data corresponding to a first mode of operation;
programming a second set of programmable registers with configuration data corresponding to a second mode of operation; and
repeatedly performing the steps of:
selecting a mode of operation,
programming a mode register according to the selected mode of operation,
connecting one of the first and second sets of programmable registers to a configurable processing block according to the mode register, and
operating the selected mode of operation.

17. The method as set forth in claim 16, wherein the electronic device is a mobile station.

18. The method as set forth in claim 16, wherein the first mode of operation is an Enhanced Data GSM Environment (EDGE) mode.

19. The method as set forth in claim 16, wherein the first mode of operation is a Wideband Code Division Multiple Access (WCDMA) mode.

20. The method as set forth in claim 16, wherein the selecting a mode of operation is performed by the electronic device.

21. The method as set forth in claim 16, wherein the electronic device includes a controller connected to program the mode register and at least one of the programmable registers.

22. The method as set forth in claim 16, wherein programming the first and second sets of programmable registers is performed when the electronic device is in an idle state.

23. The method as set forth in claim 16, wherein programming the first and second sets of programmable registers is performed upon power-up of the electronic device.
